(19) United States
(12) Patent Application Publication
(10) Pub. No.: US 2013/0024092 A1
(43) Pub. Date: Jan. 24, 2013

(54) DEVICE FOR PREVENTING THE ENGINE FROM STALLING IN A VEHICLE EQUIPPED WITH A DIESEL INJECTION SYSTEM

(71) Applicants: Christoph Klesse, Worth A.D. Donau (DE); Sebastian Pleines, Aufhausen (DE); Olaf Nebelung, Munchen (DE)

(72) Inventors: Christoph Klesse, Worth A.D. Donau (DE); Sebastian Pleines, Aufhausen (DE); Olaf Nebelung, Munchen (DE)

(21) Appl. No.: 13/521,208

(22) PCT Filed: Dec. 9, 2010
(86) PCT No.: PCT/EP2010/069302

§ 371 Date: Sep. 26, 2012

(30) Foreign Application Priority Data
Jan. 8, 2010 (DE) 10 2010 004 215.3

(51) Int. Cl. F02D 41/04

(52) U.S. Cl. 701/103; 123/462

(57) ABSTRACT

A device is provided for preventing the engine from stalling in a vehicle equipped with a diesel injection system, particularly a common-rail injection system. The device comprises a volume flow control valve, a high-pressure fuel pump, a pressure control valve, one or more injectors and a control unit. The control unit carries out a pressure control by controlling the volume pressure control valve in the idle state of the engine in a first operating mode, monitors whether a working point is present at which a release of air from the fuel is carried out and, in the event such a working point is detected, initiates a second operating mode in which a pressure control is carried out by controlling the pressure control valve.

### CROSS-REFERENCE TO RELATED APPLICATIONS

This application is a U.S. National Stage Application of International Application No. PCT/EP2010/069302 filed Dec. 9, 2010, which designates the United States of America, and claims priority to German Application No. 10 2010 004 215.3 filed Jan. 8, 2010, the contents of which are hereby incorporated by reference in their entirety.

### TECHNICAL FIELD

This disclosure concerns a device for preventing an engine from stalling in a vehicle equipped with a diesel injection system, e.g., a common rail system.

### BACKGROUND

Diesel injection systems are already known which work as so-called dual-actuator systems. In such a dual-actuator system an actuator is present to control the pressure on both the low-pressure side and on the high-pressure side. The actuator provided on the low-pressure side is a volume flow control valve (VCV), the actuator present on the high-pressure side is a pressure control valve (PCV).

DE 10 2007 039 892 A1 discloses an injection system for an internal combustion engine. This known injection system has a fuel pre-delivery pump, a high-pressure pump arranged downstream of the pre-delivery pump, a fuel distributor arranged downstream of the high-pressure pump, a pressure control or pressure limiting valve arranged downstream of the high-pressure pump and a pressure sensor. The pressure sensor, the pressure control or pressure limiting valve and the fuel distributor are components of a high-pressure module which is formed as one assembly with the high-pressure pump. Between the fuel pre-delivery pump and the high-pressure pump is provided a volume flow control valve.

In relation to the actuators of a dual-actuator system, normally the following control strategy is applied: when the engine is idling and in the lower part load range, pre-control takes place by means of the volume flow control valve and pressure control via the pressure control valve. This is to prevent too great a quantity of fuel being controlled via the pressure control valve. In all other engine working points, the pressure regulation takes place exclusively using the volume flow control valve. Only in case of need is an additional pressure reduction applied in the system by very briefly triggering the pressure control valve and hence controlling the fuel via this valve.

A disadvantage in this procedure is that the losses resulting from pressure control by means of the pressure control valve lead to an increased carbon dioxide emission from the vehicle.

To avoid this disadvantage, it has been proposed to omit the use of a pressure control valve and to control the pressure exclusively using the volume flow control valve. The disadvantage in this process however is the dynamics when the pressure is reduced, because the dynamics are in principle lower than in the case of pressure reduction via a pressure control valve. In a system without a pressure control valve, the pressure is reduced merely via the leakage of the injectors and where applicable via an additional functionality in which the injectors are controlled such that said injection leakage flows back to the tank via a return line, thus achieving a pressure reduction.

If no pressure control valve is used, it may be necessary to use a volume flow control valve which has a ball seat. Use of a volume flow control valve with a slide valve is not possible as such a slide valve in the closed state always has a leakage which lies in the order of magnitude of the idle injection quantity requirement.

Furthermore the inlet valve differential opening pressure of the volume flow control valve must be raised to a value greater than 1 bar. Only then can it be ensured that with very small delivery quantities of the pre-delivery pump of the system, air is not released from the fuel. Such small delivery quantities occur for example when the vehicle is idling and the volume flow control valve is regulated by means of a closed control loop. In the event of a release of air from the fuel, finally the high-pressure pump no longer delivers as air is still present within the pump.

Tests with a system described above have shown that after around 20 to 30 minutes' operation of the engine at idle, so much air has been generated from the fuel that within this time period in succession the pump displacers of the high-pressure pump fail, whereby finally the engine stalls and cannot be restarted without the assistance of the workshop.

Such stalling of the engine can—as explained above—be prevented if in the case of pressure control exclusively by means of a volume flow control valve, it is ensured that the volume flow control valve has a ball seat and that the inlet valve differential opening pressure is greater than 1 bar. To achieve this, however, massive intervention in the hydraulic hardware of the system is typically required.

### SUMMARY

In one embodiment, a device is provided for preventing the engine from stalling in a vehicle equipped with a diesel injection system, with a volume flow control valve, a high-pressure fuel pump, a pressure control valve, one or more injectors and a control unit, wherein the control unit, in an idle state of the engine, in a first operating mode undertakes pressure control exclusively by controlling the volume flow control valve, in this first operating mode monitors whether a working point is present at which a release of air occurs from the fuel, and in the event of detection of such a working point initiates a second operating mode in which pressure control takes place by control of the pressure control valve.

In a further embodiment, the control unit, in the context of monitoring the present working point of the engine, determines the value of the trigger signal for the volume flow control valve. In a further embodiment, the device comprises a memory in which information is stored on the value of the trigger signal for the volume flow control valve at which the volume flow control valve is closed. In a further embodiment, the memory stores information on a trigger signal differential value below which air begins to be released from the fuel. In a further embodiment, the trigger signal differential value is a trigger signal differential value determined during calibration. In a further embodiment, the control unit determines the difference between the determined value of the trigger signal for the volume flow control valve and the value of the trigger signal for the volume flow control valve stored in the memory, compares the determined difference with the trigger signal differential value stored in memory and if the determined difference is less than the trigger signal differential value stored in memory, starts a timer. In a further embodiment, the memory stores information on a critical time period and the control unit is designed so that in the event that the time measured by the timer exceeds the critical time period, it activates the second operating mode in which pressure control takes place by control of the pressure control valve.

### BRIEF DESCRIPTION OF THE DRAWINGS

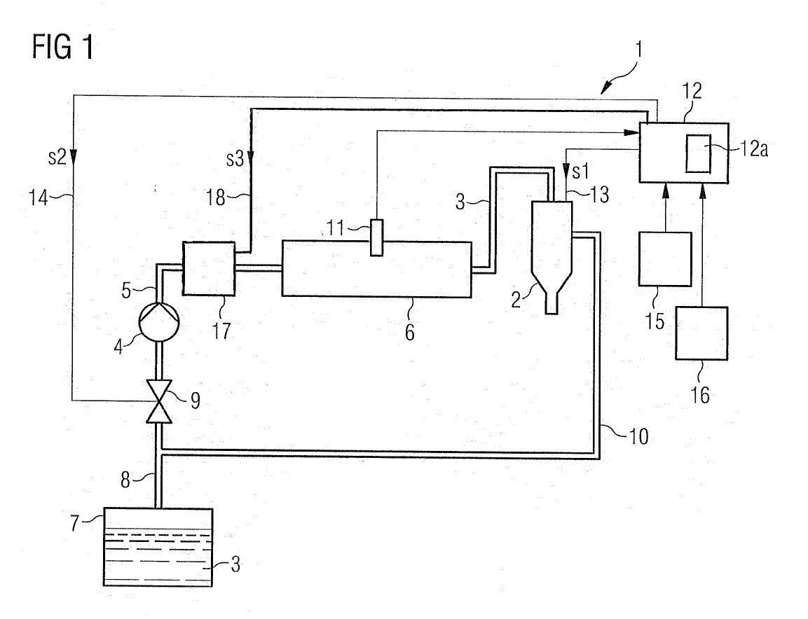

Example embodiments will be explained in more detail below with reference to FIG. 1. FIG. 1 shows a block circuit diagram of an example device to prevent the engine from stalling in a vehicle fitted with a diesel injection system, according to an example embodiment. This diesel injection system is a common rail injection system.

### DETAILED DESCRIPTION

Some embodiments provide a device to prevent the engine from stalling in a vehicle equipped with a diesel injection system which works without such massive intervention in the hydraulic hardware of the system.

Some embodiments provide a functionality that prevents the engine from stalling in the case of a release of air from the fuel at very low pump delivery levels, although the existing hydraulic hardware as such does not exclude an air release. This may be achieved by a control unit of the device which, when the vehicle is idling, in a first operating mode undertakes pressure control exclusively by controlling the volume flow control valve, in this first operating mode monitors whether a working point is present which leads to a release of air from the fuel, and in the event of detection of such a working point initiates the second operating mode in which pressure control takes place by control of the pressure control valve.

FIG. 1 shows a block circuit diagram of an example device to prevent the engine from stalling in a vehicle fitted with a diesel injection system, according to an example embodiment. This diesel injection system is a common rail injection system.

This injection system 1 has at least one injector 2 to inject fuel 3 into at least one combustion chamber (not shown). Furthermore the injection system 1 comprises a high-pressure fuel pump 4 which is connected via a rail line 5 and a pressure accumulator 6 with the injector 2. The high-pressure fuel pump 4 draws fuel 3 from a fuel tank 7 with which it is connected via a supply line 8. In the supply line 8 is a fuel pre-delivery pump not shown and a volume flow control valve 9. The latter is provided to limit the fuel quantity supplied to the high-pressure fuel pump 4.

The injector 2 has a leakage flow of fuel which is returned through a return line 10. The return line 10 opens into the supply line 8 between the fuel tank 7 and the volume flow control valve 9 or opens directly into the fuel tank 7.

In the pressure accumulator 6 is a pressure sensor 11, the output signal of which is supplied to a control unit 12. The control unit 12 is electrically connected via a control line 13 with the injector 2 and via a volume flow control trigger line 14 with the volume flow control valve 9. It supplies trigger signals s1 to the injector 2 and trigger signals s2 to the volume flow control valve 9.

Installed in the rail line 5 is a pressure control valve 17 to limit the pressure of the fuel supplied to the pressure accumulator 6. The pressure control valve 17 is controlled by the control unit 12 by means of a trigger signal s3 via a pressure control valve trigger line 18.

The control unit 12 generates the trigger signals it provides inter alia as a function of the output signal of the pressure sensor 11, the output signal of an engine rotation speed sensor 15 and the output signal of a mass air flow meter 16.

In normal operation of the device shown, the control unit 12 controls the fuel pressure predominating in the injection system by pressure control as a function of the output signal of pressure sensor 11. Necessary changes of pressure take place in that the control unit 12 supplies a relevant trigger signal to the volume flow control valve 9 or the pressure control valve 17.

In the case of pressure reduction in the system, by a corresponding control of pressure control valve 17, a comparatively large fuel quantity is diverted or controlled by means of pressure control valve 17. This is connected with a rise in carbon dioxide emission of the vehicle which is undesirable.

To avoid this undesirable rise in carbon dioxide emission from the vehicle, the control unit 12 in the idle state of the engine and in the lower part load range of the engine, both always referred to below as idle mode of the vehicle, in a first operating mode undertakes pressure control exclusively by control of the volume flow control valve 9, in this first operating mode checks whether a working point is present at which air can be released from the fuel, and in the event of detection of such a working point initiates briefly, for example for a duration of one minute, a second operating mode in which pressure control takes place by control of the pressure control valve 17.

An advantage of this procedure is that no massive intervention is required in the hydraulic hardware of existing systems which work as so-called dual-actuator systems, have differential inlet valve opening pressures of less than 1 bar and contain a volume flow control valve comprising a slide valve, in order to optimize the system in relation to its carbon dioxide emission.

In the context of detecting the release of air from the fuel, the control unit 12 determines for the present working point of the engine momentarily, i.e. for idle mode, the momentary value of the trigger signal for the volume flow control valve 9. This value may be a PWM trigger value.

A memory 12a of the device stores information on the value of the trigger signal of the volume flow control valve 9 at which the volume flow control valve is closed. Furthermore memory 12a of the device stores information on a trigger signal differential value below which air begins to be released from the fuel. This trigger signal differential value was determined in advance during calibration of the device and stored in memory 12a.

The control unit 12 is designed to form the difference between the momentary determined value of the trigger signal for the volume flow control valve and the value of the trigger signal for the volume flow control valve stored in memory 12a, to compare this difference with the trigger signal differential value stored in memory 12a and if the difference determined is less than the trigger signal differential value stored in memory 12a, to activate a timer. This timer is part of the control unit 12 and for example formed as a clock counter.

If the measured time exceeds a critical time determined during preliminary tests and also stored in memory 12a, then the control unit 12 briefly activates a second operating mode in which pressure control takes place by controlling the pressure control valve 17. As a result the fuel delivery quantity is briefly increased to supply an increased fuel quantity to the pump of the volume flow control valve and thus avoid failure of the displacers of the high-pressure pump and hence a zero delivery of the pump.

After this brief activation of the second operating mode, the control unit 12 switches the device back to the first operating mode.

The device and process described herein may prevent failure of the high-pressure pump and hence engine stalling when the engine is running at idle and in the lower part load range.

What is claimed is:

1. A device for preventing engine stalling in a vehicle equipped with a diesel injection system, with a volume flow control valve, a high-pressure fuel pump, a pressure control valve, and one or more injectors, comprising:
a control unit configured to:
in an idle state of the engine, in a first operating mode, undertake pressure control exclusively by controlling the volume flow control valve,
in the first operating mode, monitors whether a working point is present at which a release of air occurs from the fuel, and
in the event of detection of such a working point, initiate a second operating mode in which pressure control is performed by controlling the pressure control valve.

2. The device claim 1, wherein the control unit is configured to, in the context of monitoring the present working point of the engine, determine a value of the trigger signal for the volume flow control valve.

3. The device of claim 2, further comprising a memory that stores information regarding the value of the trigger signal for the volume flow control valve at which the volume flow control valve is closed.

4. The device of claim 3, wherein the memory is also stores information on a trigger signal differential value below which air begins to be released from the fuel.

5. The device of claim 4, wherein the trigger signal differential value is a trigger signal differential value determined during calibration.

6. The device of claim 5, wherein the control unit is configured to:
determine a difference between the determined value of the trigger signal for the volume flow control valve and the value of the trigger signal for the volume flow control valve stored in the memory,
compare the determined difference with the trigger signal differential value stored in memory, and
if the determined difference is less than the trigger signal differential value stored in memory, starts a timer.

7. The device of claim 6, wherein the memory also stores information regarding a critical time period, and the control unit is designed configured such that in the event that the time measured by the timer exceeds the critical time period, the control unit activates the second operating mode in which pressure control takes place by control of the pressure control valve.

8. A method for preventing engine stalling in a vehicle equipped with a diesel injection system including a volume flow control valve, a high-pressure fuel pump, a pressure control valve, one or more injectors, and a control unit, the method comprising:
in an idle state of the engine, in a first operating mode, the control unit undertaking pressure control exclusively by controlling the volume flow control valve, in the first operating mode, the control unit monitoring whether a working point is present at which a release of air occurs from the fuel, and
in the event of detection of such a working point, the control unit initiating a second operating mode in which pressure control is performed by controlling the pressure control valve.

9. The method of claim 8, further comprising, in the context of monitoring the present working point of the engine, the control unit determining a value of the trigger signal for the volume flow control valve.

10. The method of claim 9, further comprising storing information regarding the value of the trigger signal for the volume flow control valve at which the volume flow control valve is closed.

11. The method of claim 10, further comprising storing information on a trigger signal differential value below which air begins to be released from the fuel.

12. The method of claim 11, wherein the trigger signal differential value is a trigger signal differential value determined during calibration.

13. The method of claim 12, further comprising:
the control unit determining a difference between the determined value of the trigger signal for the volume flow control valve and the value of the trigger signal for the volume flow control valve stored in the memory,
the control unit comparing the determined difference with the trigger signal differential value stored in memory, and
if the determined difference is less than the trigger signal differential value stored in memory, the control unit starting a timer.

14. The method of claim 13, further comprising:
storing information regarding a critical time period, and
in the event that the time measured by the timer exceeds the critical time period, the control unit activating the second operating mode in which pressure control takes place by control of the pressure control valve.
